(19) United States
(12) Patent Application Publication
(10) Pub. No.: US 2013/0026405 A1
(43) Pub. Date: Jan. 31, 2013

(54) ROTARY VALVE AND ROTARY VALVE SEAL

(71) Applicants: James R. O'Coin, Somers, CT (US); William G. Papale, JR., Simsbury, CT (US)

(72) Inventors: James R. O'Coin, Somers, CT (US); William G. Papale, JR., Simsbury, CT (US)

(73) Assignee: HAMILTON SUNDSTRAND SPACE SYSTEMS INTERNATIONAL, Windsor Locks, CT (US)

(21) Appl. No.: 13/194,224

(22) Filed: Jul. 29, 2011

(51) Int. Cl. F16K 5/04

(52) U.S. Cl. 251/309; 277/377

(57) ABSTRACT

A rotary valve includes a housing including an inlet and an outlet. A drum is rotatably located in the housing and includes one or more fluid pathways to convey fluid flow between the inlet and the outlet. The rotary valve further includes a single-piece unitary drum seal having a portion located around a perimeter of a port of the one or more fluid pathways to seal between the drum and the housing. A drum seal assembly for a rotary valve includes a single piece, unitary drum seal disposed at a drum of the rotary valve. The drum seal has a portion extending around a perimeter of a port of one or more fluid pathways of the drum to seal between the drum and an inner wall of a housing. The drum seal assembly further includes an energizer to urge the drum seal into contact with the housing.

### GOVERNMENT RIGHTS STATEMENT

This invention was made with Government support under contract NNJ10HB94C awarded by NASA. The Government has certain rights in the invention.

### BACKGROUND OF THE INVENTION

The subject matter disclosed herein relates to valves. More specifically, the subject matter disclosed herein relates to seals for rotary valves.

Rotary valves typically include a housing with an inlet and outlet for flow of a fluid into and out of the valve. The valve typically includes a drum that is rotatable within the housing and may include a hub that is stationary relative to the housing. The drum includes a number of fluid pathways which, depending on their position relative to the inlet and outlet, defines a flow direction through the valve.

In valves of this type, control of leakage in the valve is very important so the flow can be accurately controlled. To that end, the typical rotary valve includes sealing elements located between the drum and the housing wall, and also between the drum and the hub. The seals are intended to reduce the leakage between the components thereby improving performance of the valve.

### BRIEF DESCRIPTION OF THE INVENTION

A rotary valve includes a housing including an inlet and an outlet. A drum is rotatably located in the housing and includes one or more fluid pathways therethrough to convey fluid flow between the inlet and the outlet. The rotary valve further includes a single-piece unitary drum seal having a portion located around a perimeter of a port of the one or more fluid pathways to seal between the drum and an inner wall of the housing.

A drum seal assembly for a rotary valve includes a single piece, unitary drum seal disposed at a drum of the rotary valve. The drum seal has a portion extending around a perimeter of a port of one or more fluid pathways of the drum to seal between the drum and an inner wall of a housing. The drum seal assembly further includes an energizer to urge the drum seal into contact with the inner wall of the housing.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an embodiment of a rotary valve;

FIG. 2 is a partially exploded view of an embodiment of a rotary valve;

FIG. 3 is a perspective view of an embodiment of a rotary valve drum;

FIG. 4 is a cross-sectional view of an embodiment of a rotary valve drum;

FIG. 5 is a perspective view of an embodiment of a drum seal;

FIG. 6 is a perspective view of a portion of an embodiment of a rotary valve drum; and

FIG. 7 is a partial cross-sectional view of another embodiment of a drum seal.

The detailed description explains embodiments of the invention, together with advantages and features, by way of example with reference to the drawings.

### DETAILED DESCRIPTION OF THE INVENTION

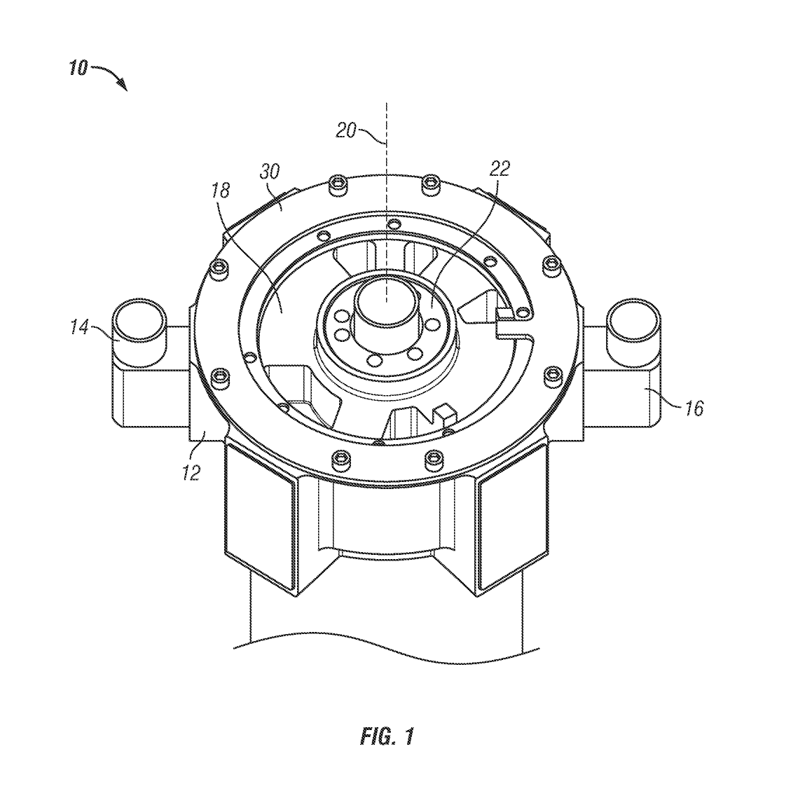

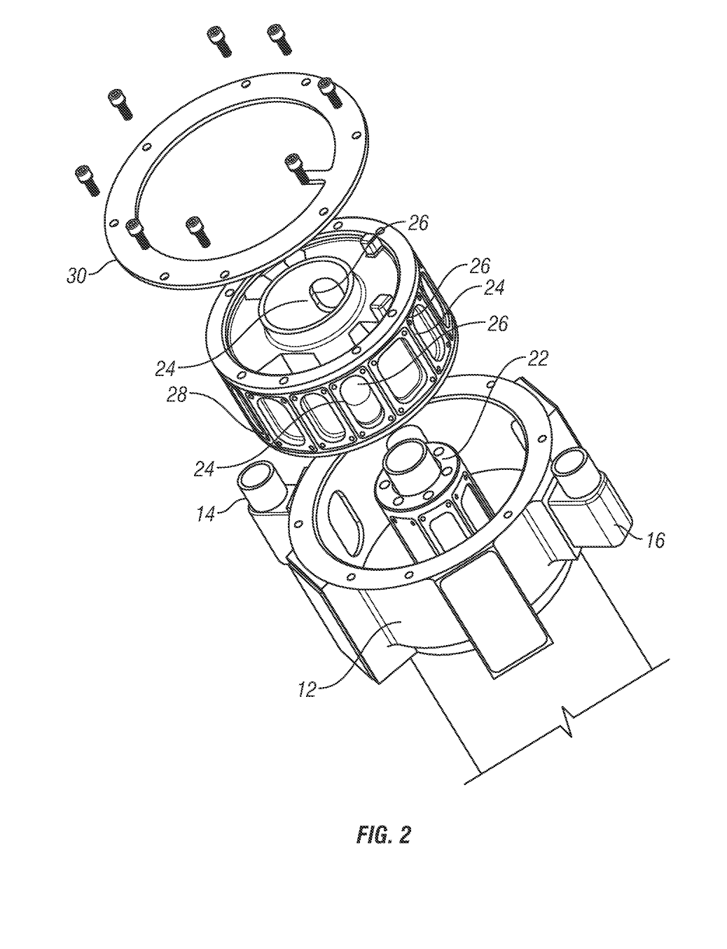

Shown in FIG. 1 is an embodiment of a rotary valve 10. The valve 10 includes a housing 12 with an inlet 14 and an outlet 16 for a fluid flow through the valve 10. A drum 18 is located in the housing 12 and is configured to rotate about a valve axis 20 relative to the housing 12 and a hub 22. In some embodiments, a drum retainer 30 is positioned over at least a portion of the drum 18 and is secured to the housing 12 to retain the drum 18 in the housing 12. Referring to the exploded view of FIG. 2, the drum 18 includes a plurality of flow paths 24 having ports 26 at an outer surface 28 of the drum 18. In some embodiments, the flow paths 24 may extend through the hub 22.

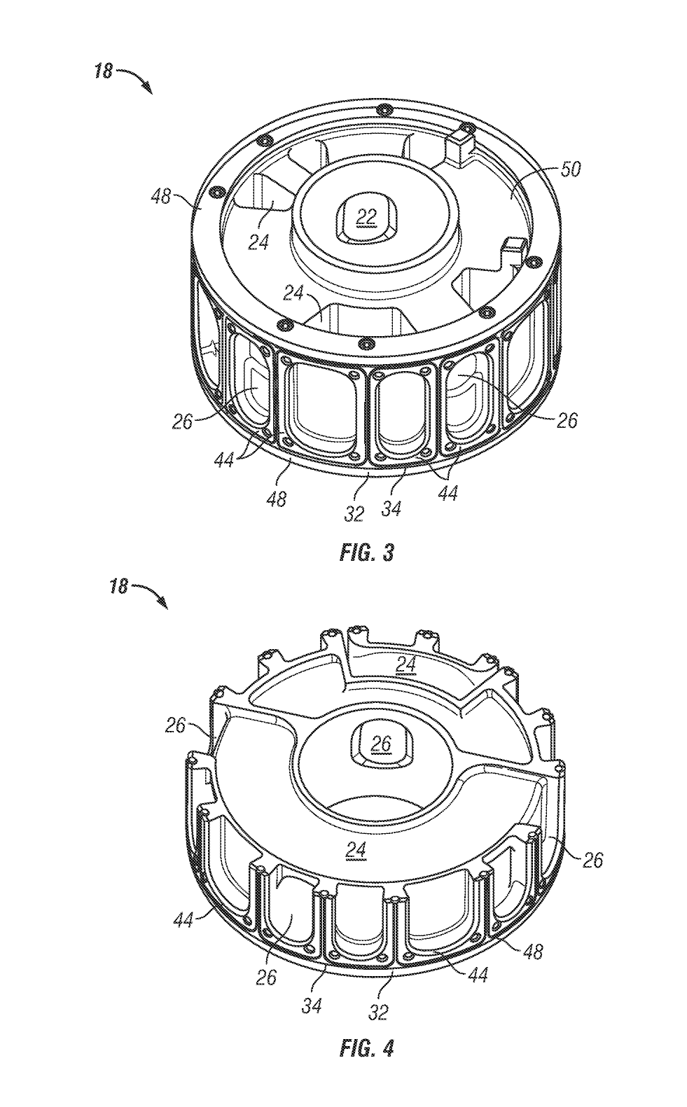

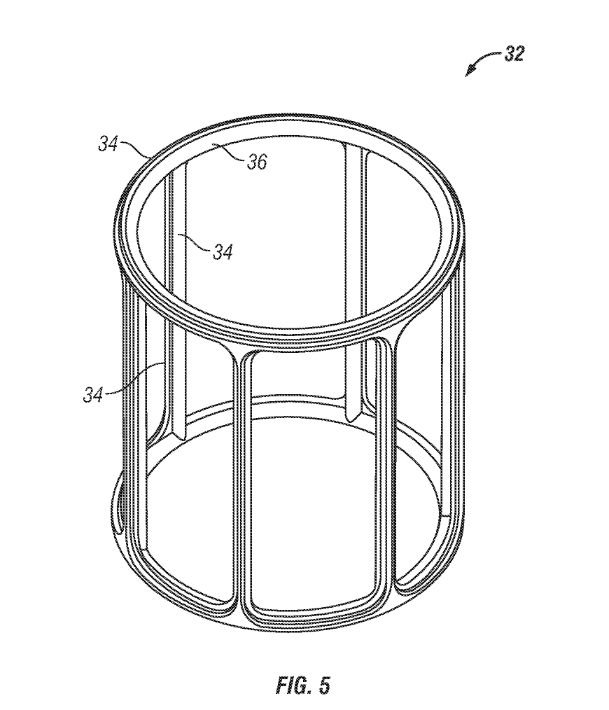

The drum 18 is shown in more detail in FIGS. 3 and 4, where the ports 26 and the flow paths 24 are clearly shown. To prevent leakage of flow between the drum 18 and the housing 12, a drum seal assembly 32 is affixed to the drum 18. In other embodiments, the drum seal assembly 32 may be affixed to the housing 12. The drum seal assembly 32, shown best in FIG. 5, includes a drum seal 34 and an energizer 36. The drum seal 34 is a unitary element that extends entirely circumferentially around the drum 18 to prevent leakage externally and also longitudinally along the drum 18, to isolate the ports 26 from each other and thereby prevent leakage internally. In some embodiments, the drum seal 34 may not extend for the entire circumference of the drum 18, but instead only that portion necessary to prevent undesirable leakage. In other embodiments, there could be one or more gaps in circumferential sections of the drum seal 34 where external leakage would not be affected. The drum seal 34 is formed from a low friction, wear resistant, rigid material, such as a stiff plastic material. The drum seal assembly 32 also includes an energizer 36, formed from an elastomer or other relatively soft material. The energizer 36 is, like the drum seal 34, unitary. The energizer 36 matches the overall general shape of the drum seal 34 in its circumferential and longitudinal directions.

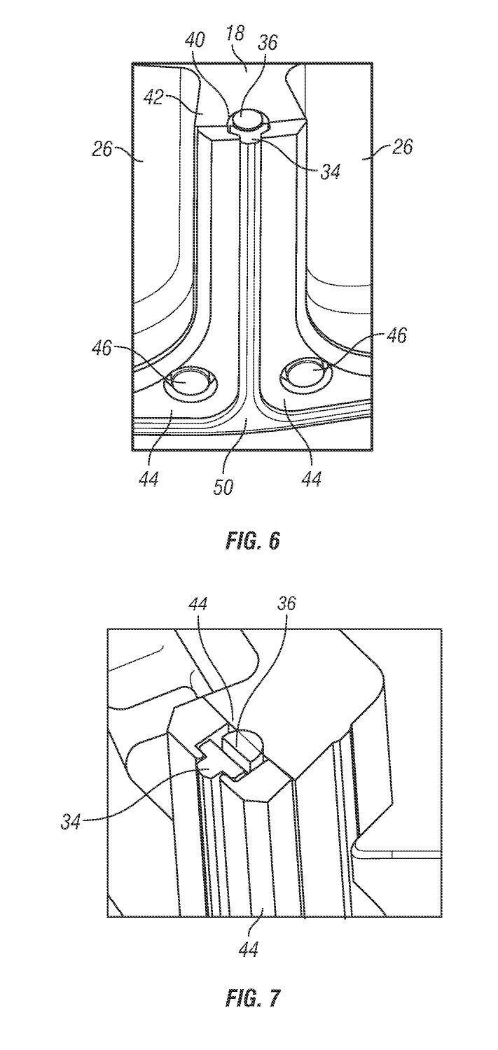

Referring now to FIG. 6, the drum seal assembly 32 is installed into a plurality of seal slots 40 at an outer surface 42 of the drum 18. In other embodiments the outer surface 42 of the drum 18 may be without slots as shown in FIG. 7. The energizer 36 is installed first, then the drum seal 34 is installed over the energizer 36. When installed, the energizer 36 urges the drum seal 34 outwardly toward the housing 12 to seal therewith. In this configuration, the energizer 36 also creates a seal between the drum seal 34 and the energizer 36 and between the energizer 36 and the drum's outer surface 42. The drum seal assembly 32 is retained on the outer surface 42 of the drum 18 by a plurality of seal frames 44. Each seal frame 44 extends around a port 26 and partially overlaps the drum seal 34 to retain the drum seal assembly 32 at the outer surface 42. In embodiments where the drum 18 is without seal slots 40, the seal frames 44 may be thickened to create the cavity for the drum seal 34 and the energizer 36. The seal frames 44 may be secured to the drum 18 by any suitable means, for example screws 46 or other mechanical fasteners. Use of screws 46 or other removable fasteners allows for easy removal of the seal frames 44 to replace the drum seal assembly 32 if desired. The seal frames 44 and the drum seal 34 are configured such that a seal tip 50 extends beyond a radial extent of the seal frames 44 to ensure sealing between the seal tip 50 and the housing 12.

Referring again to FIG. 3, to retain the drum seal assembly 32 at the longitudinal ends of the drum 18, end caps 48 are affixed to the longitudinal ends 50 of the drum 18. The end caps 48 are formed from, for example, a nonmetallic bearing material to resist wear over the life of the valve 10. The end caps 48 serve as guides to keep the drum 18 centered in the housing. The outside diameter of the end caps 48 is greater than the outside diameter created by the compliment of seal frames 44 in order to prevent contact between the seal frames 44 and the housing 12 inside diameter. Contact between the seal frames 44 and the housing 12 is undesirable as it might lead to damage to the sealing surface of the housing 12.

Referring again to FIG. 2, a hub seal assembly 50 may be provided to seal between the hub 22 and the drum 18. The hub seal assembly 50 is installed at the hub 22, and is configured substantially identical to the drum seal assembly 32 except the hub seal assembly 50 is scaled to fit between the hub 22 and the drum 18.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A rotary valve comprising:
a housing including an inlet and an outlet;
a drum rotatably disposed in the housing and including one or more fluid pathways therethrough to convey fluid flow between the inlet and the outlet; and
a single-piece unitary drum seal having a portion disposed around a perimeter of a port of the one or more fluid pathways to seal between the drum and an inner wall of the housing.

2. The rotary valve of claim 1, wherein the drum seal extends around an entire circumference of the drum.

3. The rotary valve of claim 1, wherein the drum seal extends around only a portion of the circumference of the drum.

4. The rotary valve of claim 1, wherein the drum seal includes multiple portions, each portion disposed around a port of the one or more fluid pathways.

5. The rotary valve of claim 1, wherein the drum seal is disposed at an outer surface of the drum.

6. The rotary valve of claim 1, further wherein the drum seal is disposed in a seal slot of the drum.

7. The rotary valve of claim 1, further comprising an energizer disposed between the drum seal and the drum to urge the drum seal into contact with the inner wall of the housing.

8. The rotary valve of claim 7 wherein the energizer is disposed closer to a central valve axis than the drum seal.

9. The rotary valve of claim 7, wherein the energizer is a single, unitary element.

10. The rotary valve of claim 7, wherein the energizer is formed from an elastomeric material.

11. The rotary valve of claim 1, further comprising a seal frame disposed at an outer radial wall of the drum to retain the drum seal at the drum.

12. The rotary valve of claim 1, further comprising an end cap disposed at a longitudinal end of the drum to retain the drum seal at the drum.

13. The rotary valve of claim 1, further comprising a hub disposed in the housing about which the drum is rotatable.

14. The rotary valve of claim 13, including a single-piece unitary hub seal disposed at a perimeter of a port of the one or more fluid pathways to seal between the hub and the drum.

15. A drum seal assembly for a rotary valve comprising:
a single piece, unitary drum seal disposed at a drum of the rotary valve, the drum seal having a portion extending around a perimeter of a port of one or more fluid pathways of the drum to seal between the drum and an inner wall of a housing; and
an energizer to urge the drum seal into contact with the inner wall of the housing.

16. The drum seal assembly of claim 15, wherein the energizer is a single, unitary element.

17. The drum seal assembly of claim 15, wherein the energizer is formed from an elastomeric material.

18. The drum seal assembly of claim 15, further comprising a seal frame disposed at an outer radial wall of the drum to retain the drum seal at the drum.

19. The drum seal assembly of claim 15, further comprising an end cap disposed at a longitudinal end of the drum to retain the drum seal at the drum.

20. The drum seal assembly of claim 15, further wherein the drum seal is disposed in a seal slot of the drum.
